(19) United States
(12) Patent Application Publication
(10) Pub. No.: US 2004/0136902 A1
(43) Pub. Date: Jul. 15, 2004

(54) Device and method for the catalytic reformation of hydrocarbons or alcohols

(76) Inventors: Peter Jorg Plath, Langwedel (DE); Ernst-Christoph Hass, Hauptstrasse (DE); Magnus Buhlert, Bremen (DE)

Correspondence Address: SUTHERLAND ASBILL & BRENNAN LLP, 999 PEACHTREE STREET, N.E., ATLANTA, GA, 30309, US

(21) Appl. No.: 10/474,649

(22) PCT Filed: Apr. 2, 2002
(86) PCT No.: PCT/DE02/01184

(30) Foreign Application Priority Data
Apr. 12, 2001 (DE) 10118618.5
Jul. 31, 2001 (DE) 10137188.8

(51) Int. Cl. C01B 3/26

(52) U.S. Cl. 423/651

(57) ABSTRACT

The invention relates to a process and an apparatus for catalytically reforming hydrocarbons or alcohols to hydrogen in a plurality of partial reactions. The plurality of partial reactions are performed individually and/or in combinations of at least two of the plural partial reactions in a microreactor network comprising microreactors and channels formed between the microreactors, starting substances and/or reaction products of the plural partial reactions being conveyed through at least part of the channels between reactor spaces of the microreactors. Reaction progress of the plural partial reactions in the microreactor network is controlled by way of process control means for controlling process parameters.

The invention relates to the art of catalytic reforming of hydrocarbons or alcohols.

The availability of hydrogen is the fundamental condition for use of fuel cells in mobile and stationary applications. As the use of fuel cells is becoming more frequent, for example, in automobiles it makes sense to restrict the operation of the energy generating units of the automobile to one energy source, such as methanol, gasoline, or diesel fuel rather than feeding each energy generating unit from a different source of energy, such as one for the Otto carburetor engine for driving, diesel for the heating system, and methanol for the fuel cell for air conditioning and current supply. For this reason, attempts have been made to utilize the customary fuels for the production of the hydrogen needed for the fuel cell.

It is a well established process in industry to reform higher hydrocarbons or alcohols to hydrogen. However, when applying this reforming process to obtain hydrogen for fuel cells, the equipment known to date still is rather big and, therefore, ill suited for employment in mobile installations. The cause of another problem in producing hydrogen for fuel cells by way of reforming higher hydrocarbons or alcohols is the complicated nature of the chemical processes that occur in reforming and the consequential difficulty of conducting the reaction. Known aggregates for reforming hydrocarbons or alcohols, therefore, comprise expensive means of control and regulation to handle the complicated reaction processes and thus are not suited for use in mobile installations, such as automobiles.

It is, therefore, the object of the invention to provide an improved process and apparatus for reforming higher hydrocarbons or alcohols, such as gasoline (benzine), diesel fuel, methanol, or methane, that will facilitate hydrogen production for a fuel cell in mobile equipment, especially vehicles.

This object is met, in accordance with the invention, by a process as recited in independent claim 1 and an apparatus as recited in independent claim 13.

The provision and utilization of a microreactor network with its microreactors and microchannels permit high selectivity in influencing the various partial reactions which are intricately interconnected in reforming hydrocarbons or alcohols. The small dimensions of the reaction spaces in the microreactors make it easier to regulate and keep under control the reactions taking place and, therefore, reduce the necessary expenditure for mechanical equipment.

It is another advantage that the microreactor network is particularly well suited as a means for producing hydrogen for non-industrial applications because the space requirement of the apparatus has been reduced considerably in comparison with known (industrial) installations. Apart from application in mobile equipment, the hydrogen obtained from reforming also may be put to use, for example, in fuel cells for housing energy supply systems.

According to a convenient further development of the invention the process control means comprise regulator valves Vmj (m=1, 2, . . . ; j=2, 3, . . . ) in at least the part mentioned of the channels Kmj, and the conveyance of the starting substances and/or the reaction products of the plurality of partial reactions Tk through at least the part mentioned of the channels Kmj is controlled by way of actuating the regulator valves Vmj. In this manner the flow of starting substances and/or reaction products between the microreactors can be optimized so as to optimize the chemical reactions for different applications.

In a further development of the invention, at least one other reaction substance and/or a further quantity of one or all of the starting substances is fed into one or all of the channels Kmj so as to control the process parameters by premixing. This permits targeted control of the course taken by reactions in the individual microreactors. For example, the chemical equilibrium of a reaction in one of the microreactors can be shifted by supplying a further reaction substance or a further amount of one or all of the starting substances. In the selective oxidation of CO to CO₂, the resulting H₂/CO₂ mixture under equilibrium conditions (water equilibrium) is counteractive to the selective oxidation. Now, if moistened air is fed through one of the channels it can act to shift the water equilibrium in the preferred direction. A preferred embodiment, for this reason, provides for supplying gas as the additional reaction substance to control the process parameters.

A convenient modification of the invention provides for controlling the process parameters by process control means to carry out at least part of the partial reactions Tk far off from a reaction equilibrium. Reactions in the microreactors of the microreactor network thus can be influenced purposively to yield the desired reaction products.

Optimization of the chemical reactions in reforming hydrocarbons and alcohols in order to increase the efficiency is achieved, with an advantageous embodiment of the invention, in that a supplementary reaction substance is produced in a reactor space RRx (1≦x≦p) of a microreactor Rx (1≦x≦n), is conveyed through one or more of the channels Kmj from the reactor space RRx to at least one reactor space RRy (1≦y≦p, x≠y), and is processed in the other reactor space RRy. Apart from the feedback of reaction substances thus obtained, especially the backcoupling of thermal energy between the various microreactors in the microreactor network can be exploited for taking an advantageous influence on the chemical reactions under way. For example, the thermal energy generated in exothermic reactions may be drawn upon for stimulating or controlling endothermic reactions in another microreactor so as to conduct the reaction autothermically.

It is preferred to use steam as the additional reaction substance for vapor reforming in the at least one other reactor space RRy in the context of reforming hydrocarbons or alcohols. The microreactor network thus allows targeted use of one of the microreactors for producing additional reaction substances which then are employed in one or more other microreactors to perform the respective chemical reactions taking place in them.

Further optimization of the efficiency of the chemical reactions which occur in reforming is achieved with a preferred further development of the invention with which a reaction product from one of the microreactors Rn is fed back through at least one of the channels Kmj to another one of the microreactors Rn.

A preferred further development of the invention may provide for a partial reaction Tk to be carried out in parallel in several ones of the microreactors Rn if it is desired to offer certain intermediate products in greater volumes. In this way the reaction of certain starting substances may be increased, as desired.

According to a convenient further development of the invention, the partial reactions taking place in the microreactors of the microreactor network may be specifically targeted for intervention by temperature control means incorporated in the process control means and by using the temperature control means for individually heating and/or cooling the reactor spaces RRp. In this manner, the temperature characteristics of the partial reactions in the reactor spaces RRp may be individually taken into account.

With a preferred further development of the invention, the microreactors Rn may be formed in a base block, and the base block may be preheated and/or precooled by a base block temperature control means for heating and/or cooling of the microreactors Rn. This minimizes expenditure for adjustment of a given starting temperature for the plurality of microreactors of the microreactor network. Thus a reaction environment may be established which is adapted to the respective application.

The advantages of the dependent apparatus claims correspond to the respective process claims.

The invention will be described further, by way of example, with reference to the accompanying drawing, in which:

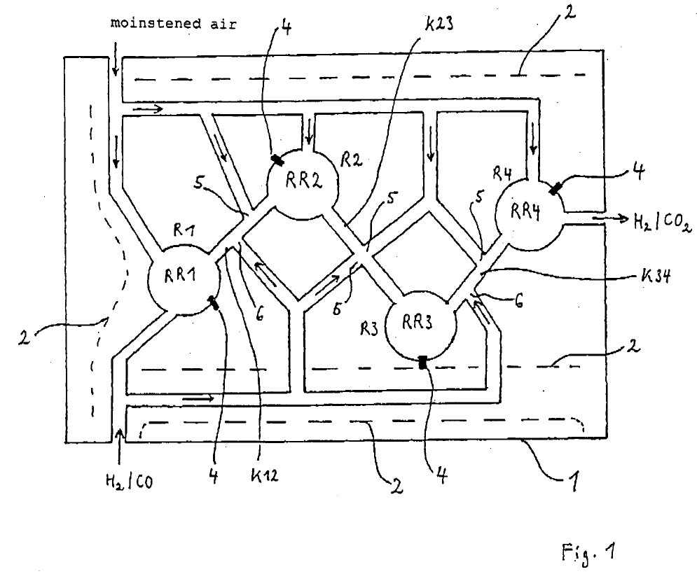

FIG. 1 shows a microreactor network for catalytic purification of a flow of hydrogen with carbon monoxide;

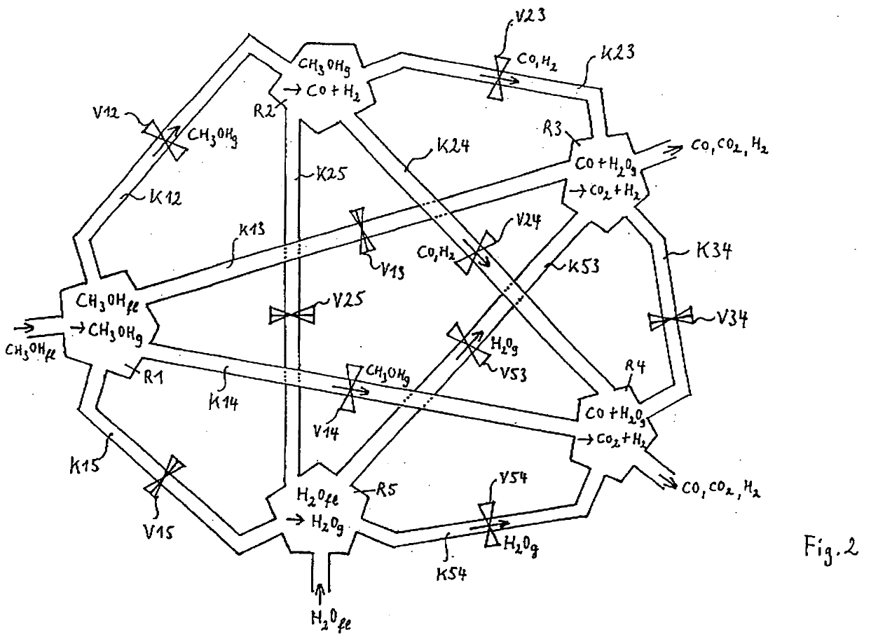

FIG. 2 shows a microreactor network comprising five microreactors for reforming methanol;

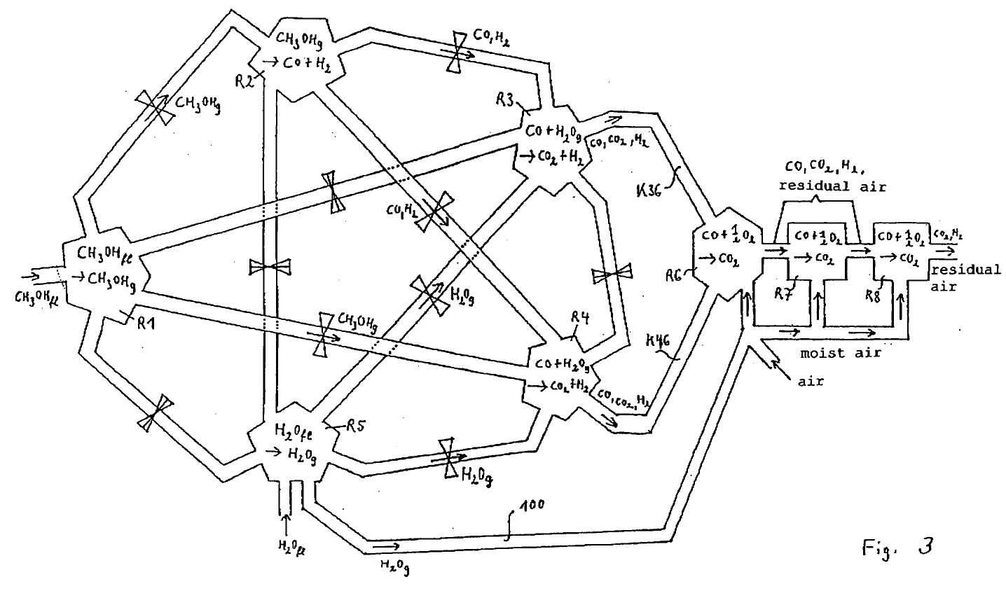

FIG. 3 shows the microreactor network of FIG. 2, with a downstream reactor chain for selective CO oxidation;

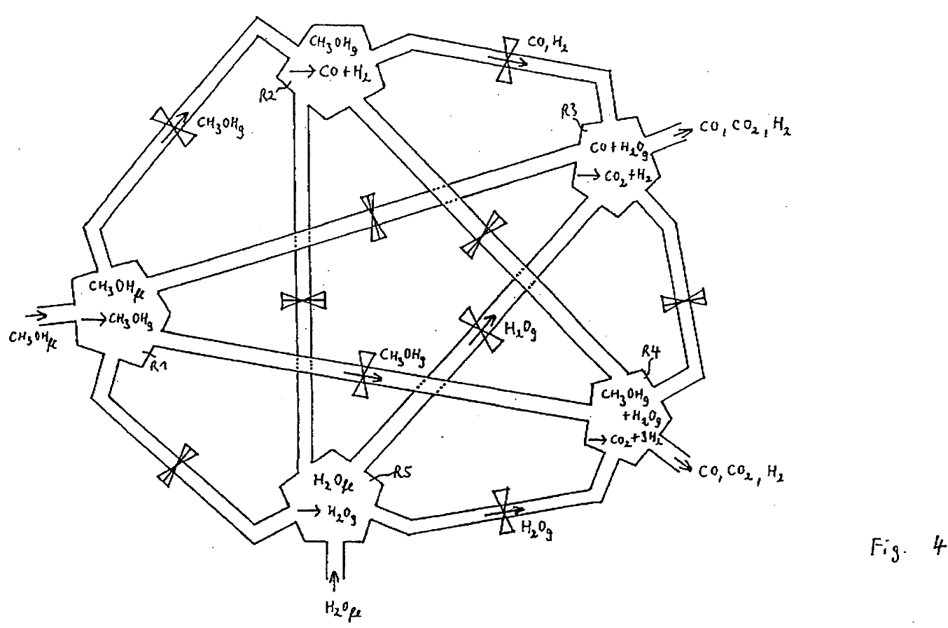

FIG. 4 shows the microreactor network of FIG. 2, with a channel between microreactors R2 and R4 being closed;

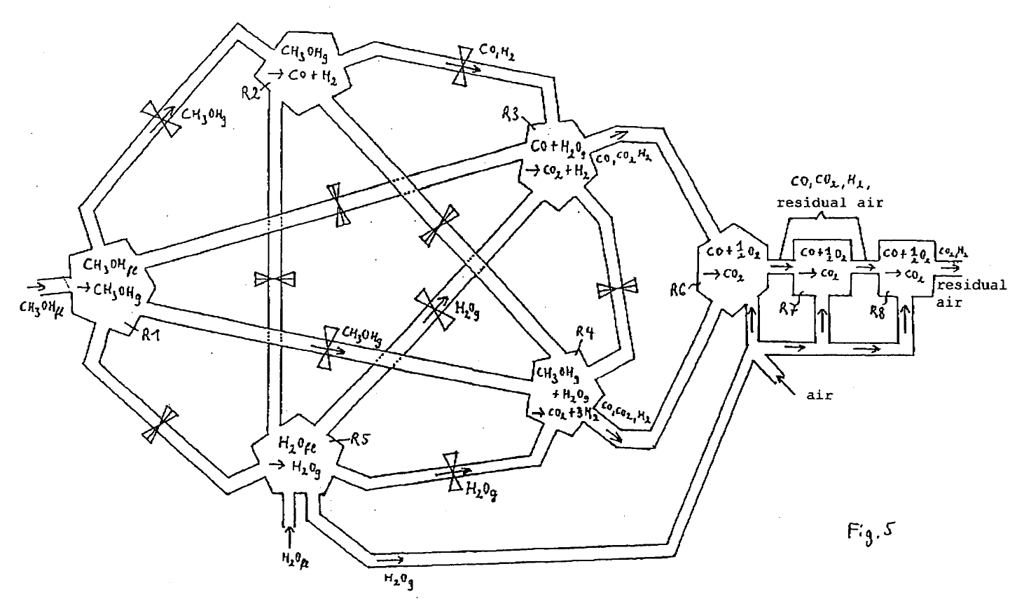

FIG. 5 shows the microreactor network of FIG. 3, with a channel between microreactors R2 and R4 being closed;

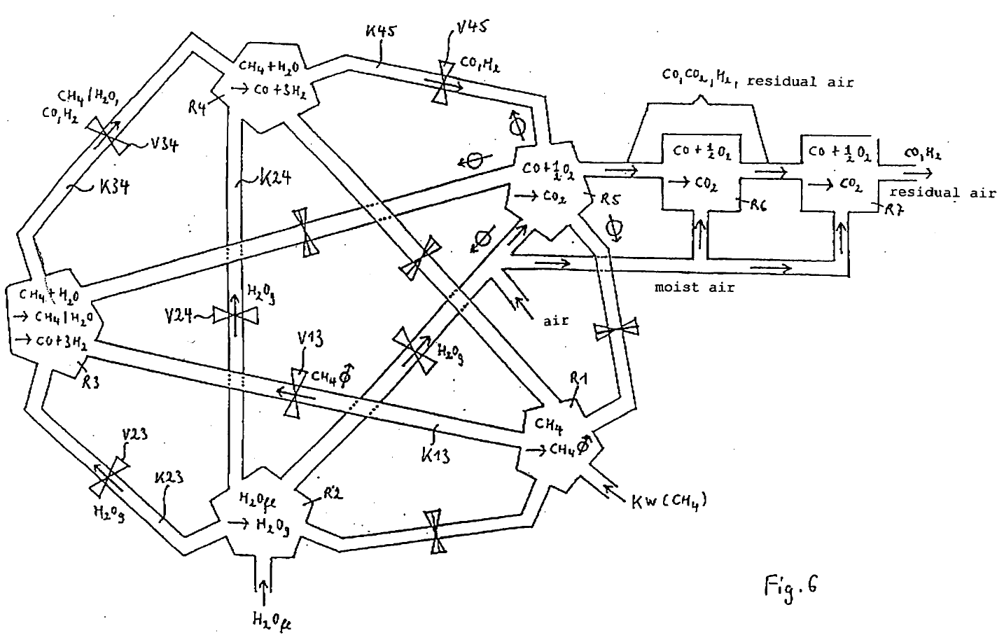

FIG. 6 shows another microreactor network for vapor reforming of methane;

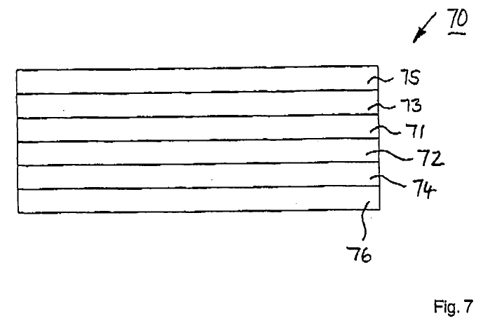

FIG. 7 is a diagrammatic representation of a microreactor means, as seen from the side;

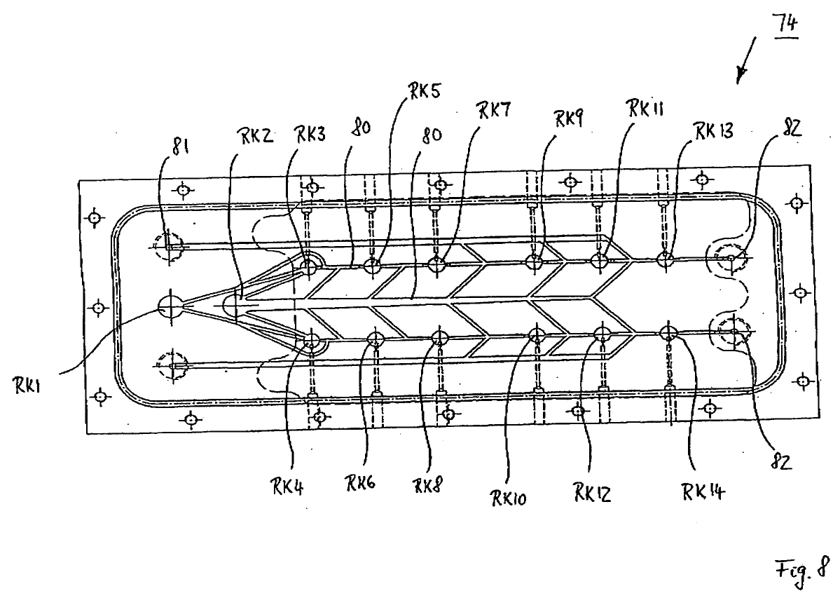

FIG. 8 shows a base plate of the microreactor means illustrated in FIG. 7, as seen from the top;

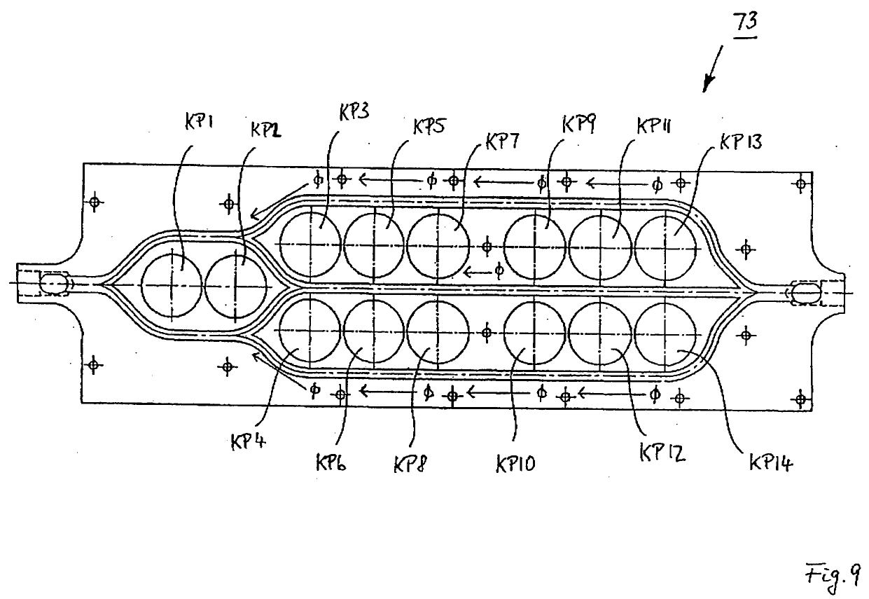

FIG. 9 shows a cooling plate of the microreactor means illustrated in FIG. 7, including a diagrammatic representation of the thermal flux Φ; and

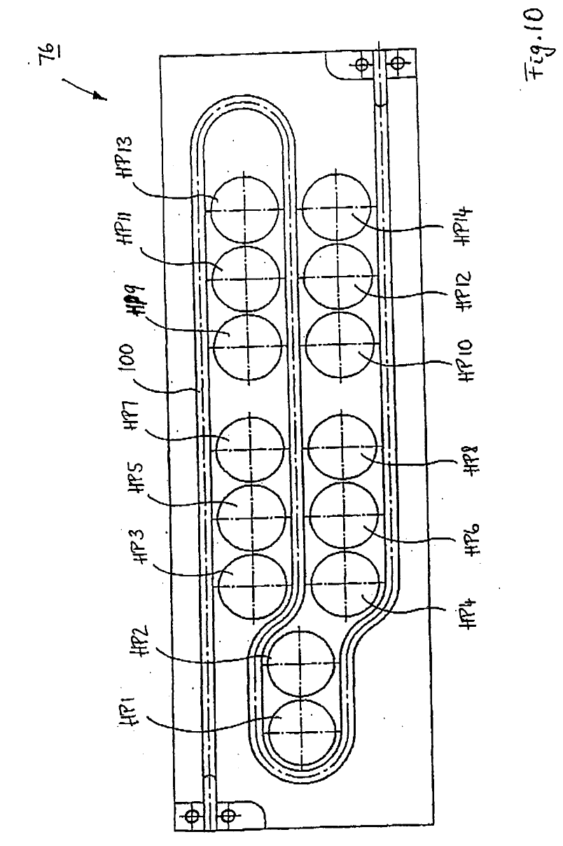

FIG. 10 shows a heater plate of the microreactor means illustrated in FIG. 7, including a heater string.

FIG. 1 is a diagrammatic presentation of a microreactor network comprising a plurality of microreactors R1 . . . R4. A highly selective, multi-stage, heterogeneous, catalytic oxidation is carried out in the microreactor network to convert the carbon monoxide (CO) contained in a hydrogen gas into carbon dioxide (CO₂) without, at the same time, significantly oxidizing the hydrogen (H₂) as well. The microreactors R1-R4 each include a reaction space RR1 . . . RR4. The reaction spaces RR1-RR4 are interconnected by channels K12, K23, and K34. The reaction substances are conveyed through the channels K12, K23, K34 between the reactor spaces RR1-RR4. Preferably, the microreactors R1-R4 ate designed as specified in the international patent application PCT/DE 01/02509, presenting a catalytic pipe reactor through which an H₂/CO mixture flows. The microreactors R1-R4 and the channels K12, K23, K34 are formed in a base block 1 in which heater filaments 2 extend so that the base block 1 can be kept at a given basic temperature. Chemical catalysts are disposed in each of the reactor spaces RR1-RR4, as disclosed in the international patent application PCT/DE 01/02509.

Not only is the temperature of the base block 1 controlled by means of the heater filaments 2, what is more also the reactor spaces RR1-RR4 can be heated individually so that their temperature may be above the basic temperature of the base block 1. The temperature in each of the reactor spaces RR1-RR4 is measured by a respective temperature sensor 4. The data measured are collected from the temperature sensors 4 to be processed by a control means and then used for adjustment of the temperature through individual heating of the reactor spaces RR1-RR4.

The channels K12, K23, K34 include gas inlets 5, 6 for feeding further gases. Gases thus may be introduced ahead of each reactor space RR1-RR4 to influence the chemical reactions taking place inside. In the case of catalytic oxidation of CO to CO₂, moistened air and an H₂/CO gas mixture are supplied through the gas inlets 5, 6, respectively. This corresponds to controlled forward mixing. This forward mixing is made use of for establishing a state far from equilibrium in the entire microreactor network, including the microreactors RR1-RR4, and maintaining that state. This greatly increases the selectivity of the catalytic oxidation from CO to CO₂ in the presence of H₂. Adding moistened air through the gas inlets 5 and a suitable choice of the flow velocity can help prevent equilibrium conditions from being adjusted in the oxidation of CO to CO₂.

The reactor spaces RR1-RR4 preferably are embodied by flat cylinders having a diameter of about ≦2 cm and a height of about ≦5 mm. The reactor spaces RR1-RR4 communicate linearly through the channels K12, K23, K34. The channels K12, K23, K34 preferably have a width of about ≦3 mm and a height of about ≦3 mm. This results in an overall size of the microreactor network of no more than a few centimeters.

Carbon monoxide from the H₂/CO gas mixture can be oxidized catalytically with a high degree of selectivity in the presence of great quantities of hydrogen. The hydrogen thus purified is suitable to be used as fuel for fuel cells since the CO content in the remaining gas is less than 100 ppm. It involves little expenditure to maintain the microreactor temperature needed for the reaction in the base block 1, including the individual reactor spaces RR1-RR4 and the channels K12, K23, K34 because of the small dimensions of the microreactor network. Use of a base block 1 made of aluminum gives the microreactor network a very low weight. The compact structure of the microreactor network, moreover, lends itself to very low energy consumption in the catalytic oxidation of CO. The base block 1 also may be made of ceramics, especially in the form of foamed ceramics. This embodiment has the advantage that ceramics is an electrically nonconductive material which makes it easier to introduce the heater filaments 2.

With this embodiment of a microreactor network, the apparatus illustrated in FIG. 1 is especially well suited for use in mobile fuel cell aggregates, for example in vehicles.

FIGS. 2 to 6 illustrate microreactor networks for catalytically reforming alcohols or higher hydrocarbons (KW). In contrast to the microreactor network shown in FIG. 1 where the microreactors RR1-RR4 are coupled one after the other in the form of a linear chain, the microreactors R1 . . . R5 in the microreactor networks shown in FIGS. 2 to 6 present a more complex structure where one microreactor may be connected to several other microreactors and backcoupling between microreactors is possible.

FIG. 2 shows a microreactor network for reforming methanol. The starting substance methanol is introduced into microreactor R1 and evaporated. The evaporated methanol passes through channels K12 and K14 to microreactors R2 and R4. Methanol is catalytically decomposed in microreactor R2.

Microreactor R4 communicates through a channel K24 with microreactor R2, through a channel K14 with microreactor R1, and through a channel K54 with microreactor R5. A water-gas-shift reaction with premixing by methanol (methanol-vapor reforming) is carried out in microreactor R4. The evaporated methanol reaches the microreactor R4 through the channel K14. The products of the catalytic decomposition of methanol in microreactor R2, and CO, and H₂ pass through the channel K24 to the microreactor R4. In addition, superheated steam obtained from water in microreactor R5, is supplied to the microreactor R4 through channel K54.

Also in microreactor R3 does a water-gas-shift reaction take place, yet other than in microreactor R4, without premixing. To this end, the microreactor R3 communicates through a channel K23 in FIG. 1 with the microreactor R2 so that CO and H₂ can be directed to the microreactor R3. Superheated steam reaches the microreactor R3 through a channel K53. The starting substances both in microreactors R4 and R3 are CO, CO₂, H₂.

As may be taken from FIG. 2, the channels between the microreactors R1-R5 each are provided with a regulator valve V12, V13, V14 . . . whereby the conveyance of substances through the channels either may be allowed or blocked. The regulator valves marked by an arrow, such as V12 and V53 are open, while the other regulator valves, such as V25 and V15 are closed.

FIG. 3 shows the microreactor according to FIG. 2, with channel K24 blocked. This means that, in the microreactor network as presented in FIG. 3, the methanol vapor reforming as well as the water-gas-shift reaction are carried out without premixing in both microreactor R3 and microreactor R4.

The microreactor networks illustrated in FIGS. 4 and 5 comprise the microreactor network shown in FIG. 2 and in FIG. 3, respectively. In addition to the microreactor networks according to FIGS. 2 and 3, respectively, the micreoreactor networks in FIGS. 4 and 5 comprise a downstream reactor chain of microreactors R6, R7, and R8 for selective CO oxidation in the presence of hydrogen. These microreactors R6-R8 are embodied by a linear reactor chain similar to the microreactor network shown in FIG. 1, and they were added in order to reduce the CO content of the starting gas mixture of the reforming process. The products, CO, CO₂, and H₂, leaving the microreactors R3 and R4 are passed through channels K36 and K46 into the microreactor R6. Through a channel 100, the microreactor R6 as well as the microreactors R7 and R8 are supplied with superheated steam from the microreactor R5 and with air which is moistened by the steam. By these means it is intended to diminish the influence of the H₂/CO₂ gas mixture resulting from the selective oxidation of CO to CO₂.

FIG. 6 shows a microreactor network comprising microreactors R1-R7 to perform vapor reforming of methane. The vapor reforming of methane essentially is carried out in that part of the microreactor network which comprises the microreactors R1-R5. Microreactors R6 and R7 are connected downstream as a linear reactor chain for purifying carbon monoxide. The mode of operation of the microreactor network presented in FIG. 6 will be explained below with reference to methane as an example. However, it may be adapted for vapor reforming any desired hydrocarbons (KW).

The methane to be reformed is introduced in microreactor R1 where it is preheated. It is then passed through channel K13 into the microreactor R3 where it is mixed catalytically with steam, the result being partial reforming. The steam is fed from microreactor R2 through channel K23 to microreactor R3. The partly reformed methane subsequently is conveyed through channel K34 to microreactor R4 where the reforming is continued at elevated temperature. Steam is fed to the microreactor R4 through channel K24. From microreactor R4, the reaction products, CO and H₂ in the form of a gas mixture, are passed to the microreactor R5. Here, moistened air is added, as in the microreactors R6 and R7, for catalytic purification of the hydrogen stream.

The carbon monoxide purification, i.e. the selective oxidation of CO to CO₂ in the microreactors R6 and R7 is an exothermic reaction. The resulting heat is returned to the microreactors R1-R4 since the processes occurring in those microreactors (in R3 and R4) are endothermic and consequently need energy to be supplied. That is especially true of the preheating of methane in the microreactor R1 and of the process of evaporating water in microreactor R2. True, this does not assure an entirely autothermic reaction performance, but the heat balance obtained is as best as possible.

The microreactors of the microreactor networks according to FIGS. 2 to 6 are similar to the microreactors in the microreactor network shown in FIG. 1 in terms of their individual dimensioning and configuration. Also the channels between the microreactors of the microreactor networks illustrated in FIGS. 2 to 6 correspond in design to the channels shown in FIG. 1. Moreover, it is provided that the microreactors according to FIGS. 2 to 6 preferably should be formed in a common base block which is adapted to be heated or cooled to a basic temperature, as explained with reference to FIG. 1. The base block is equipped with various heater means for individually raising the temperature of the respective microreactors to a temperature above the basic temperature. The various heater means may be connected to control means which control the respective heater means in response to a temperature measured by a temperature sensor in the corresponding microreactor. In the simplest case the respective heater means are a heater filament disposed in the base block in the vicinity of the associated microreactor. Thus it is possible to apply heat to the specific area of the microreactors in which a catalyst is present.

FIG. 7 is a diagrammatic side elevational view of a microreactor means 70. Two base plates 71 and 72 are formed with microreactors and channels (not shown) which interconnect the microreactors. Respective cooling plates 73 and 74 are arranged above and below the base plates 71 and 72, respectively. Respective heater plates 75 and 76 are arranged above the cooling plate 73 and below the cooling plate 74, respectively, to keep the microreactors in the base plates 71, 72 at a given basic temperature. The material of the base plates, heater plates, and cooling plates may be any material which possesses suitable heat conductivity. In the case of the microreactor means 70 the preferred material are metals, specifically brass for the heater and cooling plates 75, 76 and 73, 74, respectively. The base plate 72 which accommodates the catalyst material is made of a chromium-nickel steel which is conveniently coated with the chemical catalysts. The base plate 71 preferably is made of copper to provide optimum conductivity.

The embodiment of the elements making up the microreactor means 70 will be explained in greater detail with reference to FIGS. 8 to 10. As shown in FIG. 8, the base plate 71 comprises a microreactor network which includes fourteen reactor chambers RK1 . . . RK14 in which methanol is catalytically reformed, followed by CO purification. The base plate 71 has a length of a few centimeters, preferably about 25 cm, and a width of a few centimeters, preferably about 7 cm. The distance between the reactor chamber RK1 and reactor chamber RK13 or reactor chamber RK14 is about 16 cm. The spacing between adjacent reactor chambers, e.g. between reactor chambers RK3 and RK4 or reactor chambers RK7 and RK8 is about 4 cm. The base plate 72 has the same structure as base place 71. The dimensions indicated are examples, they may be chosen to be smaller for further miniaturization of the microreactor means 70.

The reactor chambers RK1 . . . RK14 are interconnected through channels 80. Each reactor chamber RK1-RK14 has its own heating system, being heated, for instance, by a cartridge type heater, and it disposes of sensors in the form of thermocouple elements to measure the temperature. The microreactor chambers RK1-RK14 and the channels 80 between them correspond to the microreactors and channels in the microreactor network shown in FIG. 1.

In the microreactor means 70, methanol (CH₃OH) and water (H₂O) are evaporated and subsequently catalytically reacted (reformed) in a multi-stage process, including premixing by methanol and water, to a mixture of hydrogen (H₂) and carbon dioxide (CO₂). Thereafter, shares of carbon monoxide (CO) contained in the gas mixture are reacted in another multi-stage process by heterogeneous, catalytic oxidation to form carbon dioxide, without hydrogen, at the same time, being oxidized, too, in an amount worth mentioning.

Liquid methanol is injected into reactor chamber RK1, and liquid water is injected into reactor chamber RK2. Air is fed into the system of the microreactor chambers through gas inlets 81 and passed on into the reactor chambers RK9 to RK14 through channels issuing from the gas inlets 81. The liquid methanol is evaporated in the reactor chamber RK1 and passed on into the reactor chambers RK3 to RK6 through channels issuing from the reactor chamber RK1. The liquid water is evaporated in the reactor chamber RK2 and passed through the channels issuing from reactor chamber RK2 into the reactor chambers RK3 to RK14.

The first stage each of methanol reforming (without premixing) is carried out in the reactor chambers RK3 and RK4. The second stage of methanol reforming takes place in reactor chambers RK5 and RK6, with methanol and water each being premixed with the reaction products from reactor chambers RK3 and RK4 (H₂, CO₂, CO). Apart from methanol reforming, therefore, a partial water-gas-shift reaction already takes place in the reactor chambers RK5 and RK6. That provides an improved energy balance as compared to one-stage methanol reforming since the heat released during the exothermic water-gas-shift reaction is made available directly to the strongly endothermic reforming process.

With steam added to them, the reaction products from reactor chambers RK5 and RK6 are conveyed through the respective channels into the reactor chambers RK7 and RK8. That is where the major part of the water-gas-shift reaction of CO and H₂O to CO₂ and H₂ takes place, leaving a residual portion of CO. For the residual CO content to be converted into CO₂, a chain of reactor chambers RK9, RK11, and RK13 is connected downstream of reactor chamber RK7 and a chain of reactor chambers RK10, RK12, and RK14 is connected downstream of reactor chamber RK8. It is convenient to design the two reactor chamber chains RK9-RK11-RK13 and RK10-RK12-RK14 as described in the international patent application PCT/DE 01/02509. In each of the reactor chambers RK9 to RK14 not only the respective CO₂/CO/H₂ gas mixture but also steam from reactor chamber RK1 and air are admixed. That leads to a highly selective CO oxidation in the reactor chambers RK9 to RK14, i.e. to an almost complete elimination of the CO share along the reactor chambers RK9-RK11-RK13 and RK10-RK12-RK-14, respectively, accompanied by simultaneous suppression of the oxidation of hydrogen. The products, CO₂ and H₂, leave the microreactor means 70 through the gas outlets 82 (cf. FIG. 8).

The reactions occurring in the reactor chambers at the right-hand side of the base plate 71 in FIG. 8 (selective oxidation in reactor chambers RK9 to RK14 and water-gas-shift reaction in reactor chambers RK7 and RK8) are exothermic. That applies also to the reactions in the reactor chambers RK5 and RK6. By contrast, the reforming of methanol in reactor chambers RK3 and RK4 and partly also the reactions in the reactor chambers RK5 and RK6 are endothermic, i.e. they require heat. Heat must be supplied also for evaporating methanol and water in the reactor chambers RK1 and RK2. In order to provide the optimum heat balance, cooling plates 73 and 74, respectively, are disposed above and below the base plates 71 and 72, respectively (cf. FIG. 7). They are designed to create a thermal flux 4 from the locations of the exothermic reactions to the locations of the endothermic reactions and evaporation processes. FIG. 9 illustrates the example of a cooling plate 73, as seen from the top, including cooling plate zones KP1 . . . KP14 which are disposed below the microreactor chambers RK1 to RK14 in the base plate 72. The thermal flux φ is indicated by arrows.

In an advantageous embodiment provision may be made so that the gases in the channels 80 are guided past one another in a way transferring the energy from the exothermic reactions to the endothermic reactions through heat exchange. That is achieved, for instance, by an inverted arrangement of the reactor chambers RK1-RK14 in the base plates 71 and 72, respectively.

Construction dimensions of the laboratory pattern make it necessary to apply external basic heating in order to maintain the microreactor network at a predetermined basic temperature. FIG. 10 is a top plan view of the heater plate 76. A heater string 100 is laid around heater plate zones HP1 . . . HP14 which are located in the heater plate 76 below the microreactor chambers RK1-RK14 formed in the base plate 72. In this manner, the microreactor chambers RK1-RK14 are heated from below. Heater plate 75 is designed like heater plate 76 and positioned above the cooling plate 73 for heating the reactor chambers RK1-RK14 in the base plate 71 from above (cf. FIG. 7).

In addition to the fundamental heating of the base plates 71, 72 by means of the heater plates 75 and 76, respectively, each reactor chamber RK1-RK14 can be heated individually so that the temperature in a respective reactor chamber may be higher than the basic temperature of the corresponding base plate 71 or 72. Fourteen cartridge type heaters are employed for this purpose in the microreactor means 70. Apart from measuring the temperature at the head of each heating cartridge, the temperature in the reactor spaces of the reactors R1 to R4 is measured individually by an additional temperature sensor. The data thus obtained are polled from the individual temperature sensors to be processed by a control means (not shown) and utilized for readjustment of the temperature through the individual heating of the reactor chambers RK1 to RK14.

In an advantageous embodiment having reduced dimensions the cartridge type heaters may be replaced by heater filaments which are coated with a catalyst material. That saves energy, and the fundamental heating of the base plate 71 or 72 may be reduced to a lower temperature. Besides, an even better heat exchange balance is to be expected.

The features of the invention disclosed in the specification above, in the claims, and drawings may be essential to implementing the invention in its various embodiments, both individually and in any combination.

What is claimed is:

1. A process for catalytically reforming hydrocarbons or alcohols to hydrogen in a plurality of partial reactions Tk (k=1, 2, . . . ), characterized in that the partial reactions Tk are performed individually and/or in combinations of at least two of the plural partial reactions in a microreactor network comprising microreactors Rn (n=1, 2, . . . ) and channels Kmj (m=1, 2, . . . ; j=2, 3, . . . ) formed between the microreactors Rn, starting substances and/or reaction products of the plural partial reactions Tk being conveyed through at least part of the channels Kmj between reactor spaces RRp (p=1, 2, . . . ) of the microreactors Rn, and in that courses of the process of the plural partial reactions Tk in the microreactor network are controlled by way of process control means for controlling process parameters.

2. The process as claimed in claim 1, characterized in that the process control means comprise regulator valves Vmj (m=1, 2, . . . ; j=2, 3, . . . ) in at least said part of the channels Kmj, and in that the conveyance of the starting substances and/or reaction products of the plural partial reactions Tk through at least said part of the channels Kmj is controlled by actuating the regulator valves Vmj.

3. The process as claimed in claim 1 or 2, characterized in that at least one other reaction substance and/or a further quantity of one or all of the starting substances is fed into one or all of the channels Kmj so as to control the process parameters by way of premixing.

4. The process as claimed in claim 3, characterized in that the other reaction substance for control of the process parameters is a gas which is fed in.

5. The process as claimed in any one of the preceding claims, characterized in that the process parameters are controlled by way of the process control means to carry out at least part of the partial reactions Tk far from a reaction equilibrium.

6. The process as claimed in any one of the preceding claims, characterized in that an additional reaction substance is produced in a reactor space RRx (1≦x≦p) of a microreactor Rx (1≦x≦n), is conveyed through one or more of the channels Kmj from the reactor space RRx to at least one other reactor space RRy (1≦y≦p, x≠y), and is processed in the other reactor space RRy.

7. The process as claimed in claim 6, characterized in that the additional reaction substance is steam for vapor reforming in the at least one other reactor space RRy.

8. The process as claimed in any one of the preceding claims, characterized in that a reaction product is fed back through at least one of the channels Kmj from one of the microreactors Rn to another one of the microreactors Rn.

9. The process as claimed in any one of the preceding claims, characterized in that one of the partial reactions Tk is carried out in parallel in several ones of the microreactors Rn.

10. The process as claimed in any one of the preceding claims, characterized in that the process control means comprise a temperature control means, and in that the reactor spaces Rap are heated and/or cooled individually by way of the temperature control means.

11. The process as claimed in claim 10, characterized in that adjustment of the temperature control means is effected in response to the temperature measured in a catalyst layer in the reactor spaces RRp.

12. The process as claimed in any one of the preceding claims, characterized in that the microreactors Rn are formed in a base block, and in that, for heating and/or cooling the microreactors Rn, the base block is preheated and/or precooled by way of a based block temperature control means.

13. An apparatus for catalytically reforming hydrocarbons or alcohols to hydrogen in a plurality of partial reactions Tk (k=1, 2, . . . ), characterized by a microreactor network comprising microreactors Rn (n=1, 2, . . . ), each including at least one reactor space RRp (p=1, 2, . . . ), by channels Kmj (m=1, 2, . . . ; j=2, 3, . . . ) formed between the microreactors Rn for conveying starting substances and/or reaction products of the plural partial reactions Tk between the reactor spaces RRp of the microreactors (R1 . . . Rn), and by process control means for controlling process parameters of the plural partial reactions Tk.

14. The apparatus as claimed in claim 13, characterized in that at is least part of the microreactors Rn are arranged as a linear chain of successive microreactors.

15. The apparatus as claimed in claim 13 or 14, characterized in that at least another part of the microreactors Rn are mutually interconnected through the channels Kmj so that each microreactor of the other part of microreactors Rn communicates with each other microreactor of the other part of microreactors Rn by way of the channels Kmj.

16. The apparatus as claimed in any one of claims 13 to 15, characterized in that a catalyst each is disposed in at least part of the reactor spaces RRp.

17. The apparatus as claimed in any one of claims 13 to 16, characterized in that a gas inlet each is provided in at least part of the channels Kmj for feeding a gas.

18. The apparatus as claimed in any one of claims 13 to 17, characterized in that a regulating device each is provided in the channels for controlling the flow rate.

19. The apparatus as claimed in any one of claims 13 to 18, characterized in that the microreactor network is formed in a base block.

20. The apparatus as claimed in claim 19, characterized in that the base block comprises a temperature control means for heating/cooling the microreactor network.

21. The apparatus as claimed in any one of claims 13 to 20, characterized by a reactor block comprising microreactors R1 . . . Rx (x<p) for reforming hydrocarbons or alcohols, and by a downstream reactor block comprising microreactors Rx+1 . . . Rp for selective CO oxidation.

22. The apparatus as claimed in any one of claims 13 to 21, characterized in that the microreactor network has outer dimensions of a few centimeters.
